(19) United States
(12) Patent Application Publication
(10) Pub. No.: US 2022/0374281 A1
(43) Pub. Date: Nov. 24, 2022

(54) COMPUTING RESOURCES ALLOCATION

(71) Applicant: Hewlett-Packard Development Company, L.P., Spring, TX (US)

(72) Inventors: Ravindra Ramtekkar, Pune (IN); Golokesh Patra, Pune (IN); Subhrajyoti Patra, Pune (IN)

(21) Appl. No.: 17/751,765

(22) Filed: May 24, 2022

(30) Foreign Application Priority Data
May 24, 2021 (IN) 202141023142

(51) Int. Cl. G06F 9/50

(52) U.S. Cl. CPC G06F 9/5072; G06F 9/505

(57) ABSTRACT

Aspects of the disclosure include an electronic device, comprising a processor. The processor is to receive a request to allocate computing resources, the request indicating a content type to use with the computing resources, determine available computing resources, determine a scoring of the computing resources according to the content type, and allocate a portion of the available computing resources according to the request, the content type, and the scoring.

### BACKGROUND

Shared or pooled computing resources, such as cloud or networked resources, may be allocated to users upon request. The computing resources may be provisioned or instantiated with data unique to a user request, or unique to the user, such as user preferences, user-generated content, or the like.

### BRIEF DESCRIPTION OF THE DRAWINGS

Various examples are described below referring to the following figures:

FIG. 1 is an electronic device having a processor and a controller in accordance with various examples.

FIG. 2 is a flow diagram of a method to allocate computing resources in accordance with various examples.

FIG. 3 is a flow diagram of a method to allocate computing resources in accordance with various examples.

FIG. 4 is a flow diagram of a method to allocate computing resources in accordance with various examples.

### DETAILED DESCRIPTION

Computing resources in a system may be allocated or distributed to system users based on requests from users, monitored data, etc. However, challenges may exist in such a system. For example, settings, configurations, and other user data that are a part of the computing resources may persist while the instance of the computing resources is allocated to the user. In addition, manual input may be involved in allocating and managing the computing resources for particular use cases, such as to provide specific details for allocation of the computing resources and/or to provide a more appropriate type of cloud resource for a particular use case than might otherwise be provided. Furthermore, a computing resource platform may change implementations or allocations to support changing user requests, and at least some computing resource systems may be platform dependent.

Some aspects of this disclosure provide for an intelligent distributor for resources, such as computing resources. The distributor may allocate and manage allocated instances of computing resources, such as virtual machines, clusters, pools, containers, etc. The distributor may make at least some decisions regarding the allocation and management of computing resources based on machine learning, such as machine learning performed according to prior usage patterns of at least some users. The distributor may allocate computing resources to a user based on the user's intended use for the computing resources, or a content with which the user intends to use the computing resources, and without the user providing particular implementation details for the computing resource, such as an amount or type of memory, etc. The distributor may perform hot-swapping, such as changing resources allocated to a particular instance of computing resources without tearing down and/or recreating that particular instance of the computing resources. The distributor may also maintain settings, configurations, and/or other user data independently of an instance of computing resources, but applied to the instance of the computing resources.

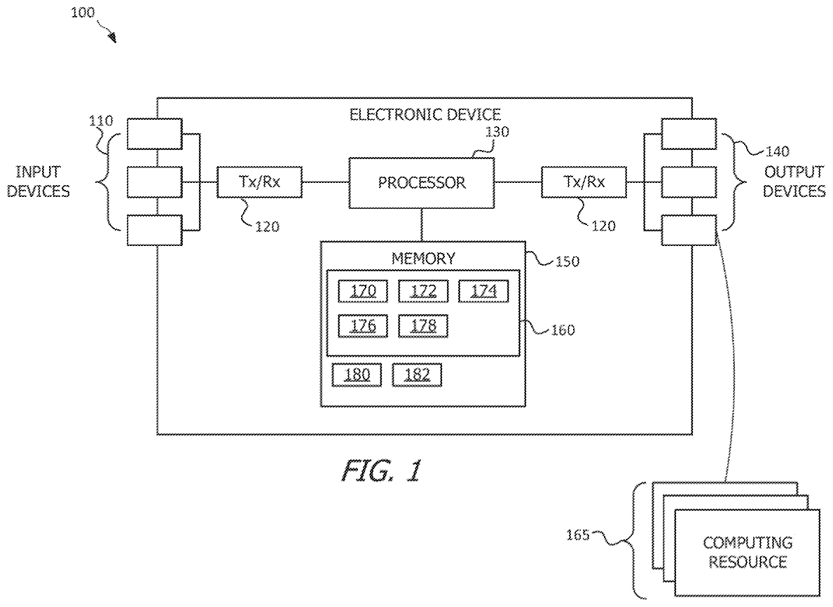

FIG. 1 is a block diagram depicting an electronic device 100, in accordance with some examples. Electronic device 100 may be any suitable computing or processing device capable of performing the functions disclosed herein such as a computer system, a laptop (or other such) device, a tablet device, a smartphone, a personal computer, a server, an Internet of Things device, a cloud computing node, etc. Electronic device 100 may implement at least some of the features/methods disclosed herein, for example, as described below with respect to any of the method 200, method 300, and/or method 400.

The electronic device 100 may comprise input devices 110. Some of the input devices 110 may be microphones, keyboards, touchscreens, buttons, toggle switches, cameras, sensors, and/or other devices that allow a user to interact with, and provide input to, the electronic device 100. Some of the input devices 110 may be downstream ports coupled to a transceiver (Tx/Rx) 120, which may be transmitters, receivers, or combinations thereof. The Tx/Rx 120 may transmit and/or receive data to and/or from other computing devices via at least some of the input devices 110. The electronic device 100 may also comprise a plurality of output devices 140. Some of the output devices 140 may be speakers, a display screen (which may also be an input device such as a touchscreen), lights, or any other device that allows a user to interact with, and receive output from, the electronic device 100. At least some of the output devices 140 may be upstream ports coupled to another Tx/Rx 120, where the Tx/Rx 120 may transmit and/or receive data from other nodes via the upstream ports. The downstream ports and/or the upstream ports may include electrical and/or optical transmitting and/or receiving components. In other examples, the electronic device 100 may comprise antennas (not shown) coupled to the Tx/Rx 120. The Tx/Rx 120 may transmit and/or receive data from other computing or storage devices wirelessly via the antennas. In yet other examples, the electronic device 100 may include additional Tx/Rx 120 such that the electronic device 100 may have multiple networking or communication interfaces, for example, such that the electronic device 100 may communicate with a first device using a first communication interface (e.g., via the Internet) and may communicate with a second device using a second communication interface (e.g., another electronic device 100 without using the Internet).

A processor 130 may be coupled to the Tx/Rx 120 and some of the input devices 110 and/or output devices 140 and may implement the computing resource distribution, allocation, and/or provisioning described herein, such as via a resource distributor executable computer program product 160. In an example, the processor 130 may comprise multi-core processors and/or memories 150, which function as data stores, buffers, etc. The processor 130 may be implemented as a general processor or as part of application specific integrated circuits (ASICs), field-programmable gate arrays (FPGAs), and/or digital signal processors (DSPs). Although illustrated as a single processor, the processor 130 is not so limited and may comprise multiple processors. In some examples, the processor 130 may be, or may be referred to as, a central processing unit (CPU).

FIG. 1 also illustrates that a memory 150 may be coupled to the processor 130 and may be a non-transitory medium to store various types of data. The term “non-transitory” does not encompass transitory propagating signals. Memory 150 may comprise memory devices including secondary storage, read-only memory (ROM), and random-access memory (RAM). The secondary storage may comprise disk drives, optical drives, solid-state drives (SSDs), and/or tape drives and may be used for non-volatile storage of data and as an overflow storage device if the RAM is not large enough to hold all working data. The secondary storage may be used to store programs that are loaded into the RAM when such programs are selected for execution. The ROM may be used to store instructions and/or data that are read during program execution. The ROM may be a non-volatile memory device that may have a small memory capacity relative to the larger memory capacity of the secondary storage. The RAM may be used to store volatile data and perhaps to store instructions. Access to both the ROM and RAM may be faster than to the secondary storage.

The memory 150 may be used to store the instructions for carrying out the various examples described herein. For example, the memory 150 may comprise the resource distributor executable computer program product 160, which may be executed by the processor 130.

By programming and/or loading executable instructions onto the electronic device 100, one of the processor 130 and/or the memory 150 may be changed, transforming the electronic device 100 in part into a particular machine or apparatus, for example, a computing resource distribution device having the functionality taught by the present disclosure.

In at least some examples, the electronic device 100 controls and/or otherwise interacts with computing resources, such as computing resources 165, to allocate, provision, or otherwise designate at least a portion of the computing resources for use by a user. For example, the resource distributor executable computer program product 160 may include an identity management module 170, a content parameter gateway module 172, a packing module 174, an intelligent distribution module 176, and a platform implementation module 178. The memory 150 may further include a user content cache 180 and a database 182. As used herein, a module may be a grouping of computer-executable instructions, or computer-executable code, such as portion of code of the resource distributor executable computer program product 160, that is configured or programmed to perform a particular task or tasks. For example, modules, such as those described herein, may be executed or otherwise implemented by the processor 130 to perform the functions ascribed to the respective modules herein. In various examples, the computing resources 165 may include, or be, virtual machines (VMs), containers, clusters, resource pools, or any other type of sharable or distributable computing resource, such as graphic processing unit (GPU) processing capacity, etc.

The electronic device 100 may receive input from the user indicating content for use with a computing resource, credentials of the user, or any other suitable information or specification for computing resources to be allocated to the user. For example, the identity management module 170 may receive user input indicating an identity of the user. Based on the received user input, the identity management module 170 may determine whether the user is registered with a resource distributor implemented according to the resource distributor executable computer program product 160, whether the user has a subscription associated with the resource distributor, an application (such as may be provisioned to or implemented at least partially by at least some of the computing resources 165, and/or least some of the computing resources 165, etc. The identity management module 170 may make the determinations, in at least some examples, by querying databases with at least a portion of the received user input as an input parameter to the database query. The identity management module 170 may provide an output including information about the user. In at least some examples, the identity management module 170 provides the output including information about the user to a packing module 174.

As described above, the electronic device 100 may also receive user input indicating content for use with a computing resource 165 or other parameters related to a computing resource 165, such as a user request or user provided parameters for the computing resource 165. For example, the content parameter gateway module 172 may receive the user input indicating content for use with a computing resource 165. The user input indicating content for use with a computing resource 165 may specify, for example, that the user is requesting a computing resource 165 for gaming, and may further specify a particular game for use with the computing resource. In another example, the user input indicating content for use with a computing resource 165 may specify that the user is requesting a computing resource for video rendering. The content parameter gateway module 172 may operate as a pass-through, providing the user input indicating content for use with a computing resource as an output of the content parameter gateway module 172. For example, the content parameter gateway module 172 may provide its output to the packing module 174. In at least some examples, the content parameter gateway module 172 may be omitted such that the packing module 174 receives the user input indicating content for use with a computing resource directly.

In at least some examples, the packing module 174 may receive inputs from the identity management module 170 and the content parameter gateway module 172. Based on the received inputs, the packing module 174 may query the user content cache 180 for information. For example, the packing module 174 may query the user content cache 180 for information related to prior usage by the user of at least some of the computing resources 165, such as previous gameplay or save date, previous settings, user-specific content, user-generated content, computing resource configuration data associated with the user, etc. In at least some examples, such as if the user content cache 180 includes data relevant to the inputs received by the packing module 174 from the identity management module 170 or the content parameter gateway module 172, the packing module 174 receives data from the user content cache 180 responsive to its query. In other examples, the packing module 174 may not receive data from the user content cache 180 responsive to its query, such as if the user is a new user, the user does not have any data stored in the user content cache 180 relevant to the inputs received by the packing module 174 from the identity management module 170 or the content parameter gateway module 172, etc. The packing module 174 may package the inputs received from the identity management module 170 and the content parameter gateway module 172, as well as data received from the user content cache 180, and may provide that packaged data to the intelligent distribution module 176. In at least some examples, the packaged data is packaged as a structured request that may be provided to the intelligent distribution module 176.

The intelligent distribution module 176 may receive the packaged data from the packing module 174 and may determine which of the computing resources 165 to allocate, provision, or otherwise assign and make available to the user. For example, based at least partially on the packaged data and availability of various of the computing resource 165, the intelligent distribution module 176 may determine which of the computing resources 165 to make available to the user. In some examples, the intelligent distribution module 176 may also receive feedback indicating performance metrics or other operational characteristics of computing resources 165 that have been made available to the user. In other examples, the intelligent distribution module 176 may also receive feedback indicating performance metrics or other operational characteristics of computing resources 165 that have been made available to other users having similar requests or user provided parameters for the computing resources 165.

The database 182 may include multiple data tables including a static information table, a feedback table, and an output table. The static information table may include information about the computing resources, such as a physical location of the computing resource 165, a type of the computing resource 165, an amount of memory of the computing resource 165 (e.g., such as RAM), a network throughput of the computing resource 165, a number of processing cores of the computing resource 165, a CPU time or CPU utilization of the computing resource 165, etc. The feedback table may include information indicating usage metrics of at least some of the computing resources 165, such as the physical location of the computing resource 165, a network capability of the computing resource 165, a CPU capability of the computing resource 165, whether processing of the computing resource 165 is throttled, a timestamp of the usage metrics, etc. In at least some examples, the intelligent distribution module 176 may generate the output table. For example, the intelligent distribution module 176 may determine scores for each of the computing resources 165 and record the scores in the output table.

In at least some examples, the intelligent distribution module 176 may determine the scores according to a machine learning process. For example, the intelligent distribution module 176 may implement a machine learning model, such as K-means Clustering, an Artificial Neural Network (ANN) Backpropagation, or any other suitable type of machine learning model. The machine learning process may determine the scores based at least partially on the static information table and the feedback table. In at least some examples, the machine learning process may determine the scores that are recorded in the output table at least partially based on attributes associated with, included in, or determined according to, the user's request for computing resources 165. For example, in some implementations, attributes used in the machine learning process for scoring the computing resources 165 may be weighted according to the request. The attributes may include a source of the requested computing resources 165, a location of the user, an identity of the user, a type of computing resource 165 requested by the user, an amount of memory associated with the request, and amount of graphics capability associated with the request, a network throughput associated with the request, a number of processing cores associated with the request, and/or a CPU time associated with the request.

The machine learning process may further determine the scores that are recorded in the output table based on attributes associated with the computing resources 165. The attributes may include a source of the computing resources 165, a time of day, a location of the computing resource 165, a type of the computing resource 165, a memory capability of the computing resource 165, a network capability of the computing resource 165, a CPU capability of the computing resource 165, a latency of the computing resource 165, and/or whether the computing resource 165 is experiencing throttling.

The machine learning process may generate the output table to include an identification of the user, an identification of a computing resource 165 selected according to the machine learning process to be suitable for servicing the user's request, a determined score of the selected computing resource 165, a determined network score of the computing resource 165, a determined CPU score of the computing resource 165, a determined graphics score of the computing resource 165, and/or a memory score of the computing resource 165.

In some examples, the intelligent distribution module 176 determines each of the scores and generates an output table uniquely for each request received by the resource distributor such that the scores are at least partially based on contents of the received request. In other examples, the intelligent distribution module 176 determines the scores without respect to the contents of the received request such that a same output table with same scores is used with multiple received requests. In yet other examples, the intelligent distribution module 176 may determine at least some of the scores of the output table with respect to the contents of the received request and/or may reuse previously determined scores, such as scores determined for similar content types, the same user, a similar user location, a same computing resource type, etc.

In at least some examples, the scores may include a location score, a CPU score, a graphics score, a memory score, and a network score. In other examples any other suitable scores associated with the computing resources 165 may be determined. The location score may be determined according to determined latency of the computing resources 165, such as a current latency and/or average latency over and suitable time period or timer periods. For example, the location score may be determined according to deviation of latency of a computing resource 165 from an ideal latency, an average latency of all of the computing resources 165, or any other suitable latency reference value. The CPU score may be determined at least partially according to the CPU capability, the graphics score may be determined at least partially according to a graphics capability, the memory score may be determined according to a size of the memory, latency of the computing resource 165, and a number of memory chips in the memory, the network score may be determined according to the latency of the computing resource 165 and the bandwidth of the latency of the computing resource 165, etc.

Based on the scores of the output table, the packaged data, and current availability of the computing resources 165, the intelligent distribution module 176 may determine and allocate or provision to the user, at least some of the computing resources 165. For example, the intelligent distribution module 176 may determine at least some of the computing resources 165 to allocate to the user via the machine learning process based on an available computing resource 165 determined to be most suitable for the user according to the user input received by the content parameter gateway module 172 and the scores of the output table.

In some examples, the intelligent distribution module 176 may re-allocate some of the computing resources 165 to the user on the fly. For example, while at least some of the computing resources 165 are allocated to the user, the intelligent distribution module 176 may determine that the allocated computing resources 165 are underperforming, or performing in a less than optimal manner. For example, a CPU usage of the allocated computing resources 165 may exceed a threshold, a latency of the allocated computing resources 165 may exceed a threshold, etc. In response, the intelligent distribution module 176 may determine other of the computing resources 165 to allocate to the user based on the feedback about the user's usage of the computing resources 165. The intelligent distribution module 176 may allocate the other of the computing resources 165 on the fly, such as without causing a disruption in service provided to the user via the computing resources 165.

In at least some examples, the intelligent distribution module 176 may allocate computing resources 165 to the user via the platform implementation module 178. For example, the intelligent distribution module 176 may provide an output signal to the platform implementation module 178 including an address of a computing resource 165 determined to be allocated to the user, a type of the computing resource 165 determined to be allocated to the user, and an address of user content to be instantiated on, or via, the computing resource 165 determined to be allocated to the user. The platform implementation module 178 may provision or allocate the computing resource 165 determined to be allocated to the user, to the user. In at least some examples, the platform implementation module 178 may query the user content cache 180 for information related to prior usage by the user of at least some of the computing resources 165, such as previous gameplay or save date, previous settings, user-specific content, user-generated content, computing resource configuration data associated with the user, etc. In at least some examples, the platform implementation module 178 receives data from the user content cache 180 responsive to its query and applies the received data to the computing resources 165 provisioned to the user.

In some examples, the platform implementation module 178 receives feedback from the computing resources 165, as described above, and provides the feedback to the intelligent distribution module 176 for updating the feedback table of the database 182, as described above. Also, in some examples, the platform implementation module 178 monitors usage of provisions computing resources 165 by the user and, based on that usage, updates the user content cache 180.

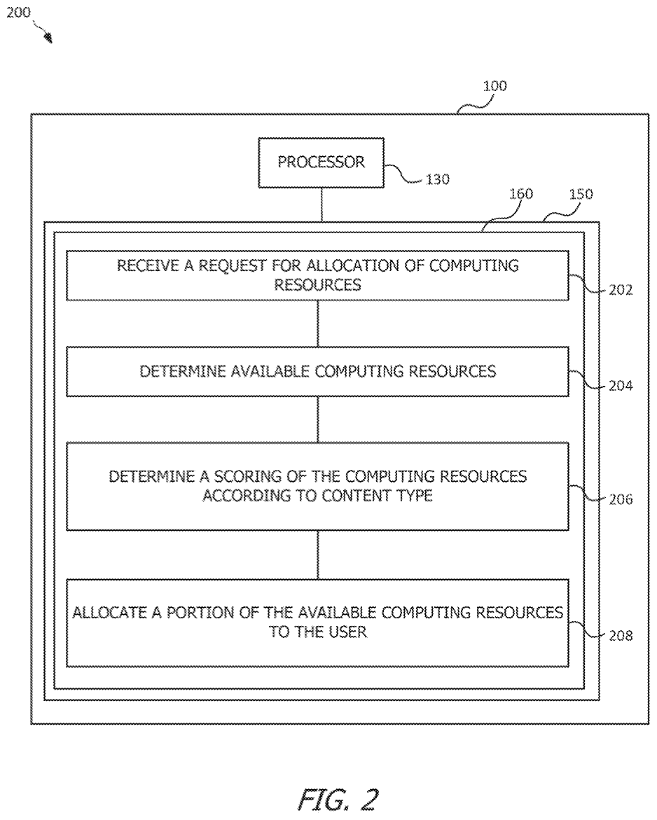

FIG. 2 shows a flow diagram of a method 200 for allocation of computing resources to a user. In at least some examples, the method 200 may be suitable for implementation on an electronic device, such as the electronic device 100 of FIG. 1. Accordingly, the method 200 may be implemented at least in part as computer-executable instructions or code, stored on a computer-readable medium, such as the memory 150 of FIG. 1, which, when executed by a processor, such as the processor 130 of FIG. 1, may cause the processor 130 to execute computer-executable instructions, such as the resource distributor executable computer program product 160, to perform operations of the method 200. The method 200 is shown in FIG. 2 as instructions of the resource distributor executable computer program product 160, stored in the memory 150 of the electronic device 100. However, in other examples the method 200 may be implemented on other devices.

At operation 202, a request for allocation of computing resources is received. In at least some examples, the request may indicate a content type for use with the computing resources. For example, the request may indicate that the computing resources are for gaming use, video rendering, crypto mining, streaming, machine learning or artificial intelligence applications, etc. In at least some examples, the request may also include identifying information of a user making the request.

At operation 204, available computing resources may be determined. In some examples, the available computing resources may be determined according to the static information table (e.g., all available computing resources), as described above. In other examples, the available computing resources may be determined according to which of the computing resources listed in the static information table have not been allocated or provisioned to a user at a time at which the available computing resource 165 are determined.

At operation 206, a scoring of the computing resources according to the content type is determined. In at least some examples, the scoring of the computing resource may be determined at least partially according to a machine learning process or model. The scoring may indicate a suitability of the computing resources to the content type and/or for the user (e.g., such as computing characteristics of the content type, a location of the user, etc.). In some examples, the machine learning model may be a K-means Clustering model and/or an ANN Backpropagation model that incorporates historical data and substantially current data for the computing resources.

At operation 208, a portion of the available computing resources may be allocated to the user according to the request, the content type, and the scoring. For example, the processor may compare information of the request and/or the content type to the scoring to determine which of the available computing resources are most suitable for allocating to the user based on the request and the content type. In at least some examples, user content is obtained from a user content cache and provisioned to the computing resource allocated to the user, such as to customize or personalize the allocated instance of the computing resource to the user.

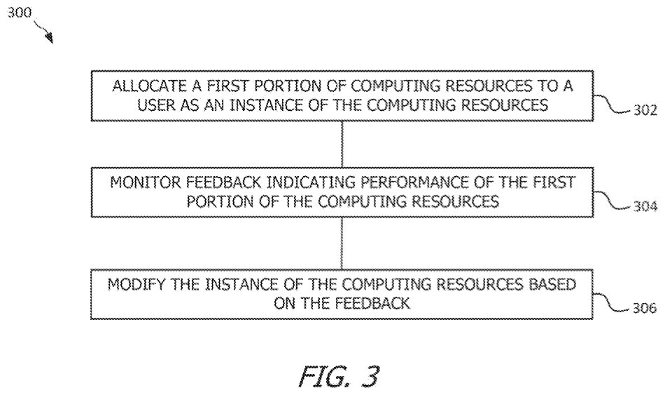

FIG. 3 is a flow diagram of a method 300 for allocation of computing resources to a user. In at least some examples, the method 300 may be suitable for implementation on an electronic device, such as the electronic device 100 of FIG. 1. Accordingly, the method 300 may be implemented at least in part as computer-executable instructions or code, stored on a computer-readable medium, such as the memory 150 of FIG. 1, which, when executed by a processor, such as the processor 130 of FIG. 1, may cause the processor 130 to execute computer-executable instructions, such as the resource distributor executable computer program product 160, to perform operations of the method 300.

At operation 302, a first portion of computing resources are allocated to a user as an instance of the computing resources. In at least some examples, the first portion of the computing resources are allocated at least partially according to a machine learning process. For example, the computing resources may be ranked, scored, or otherwise graded to indicate their suitability with respect to a content type for which a user requests allocation of the computing resources. Based on the ranking, the first portion of the computing resources may be selected and allocated to the user as the instance of the computing resources.

At operation 304, feedback indicating performance of the first portion of the computing resources is monitored. In at least some examples, the feedback indicated a CPU performance of the first portion of the computing resources. In other examples, the feedback indicates a latency of the first portion of the computing resources. In other examples, the feedback indicated a memory usage of the first portion of the computing resources. In various other examples, the feedback may indicate any suitable performance metrics of, or associated with, the first portion of the computing resources. In at least some examples, the feedback may be compared to thresholds, benchmarks, or other data indicating minimum performance metrics deemed sufficient for the instance of the computing resources.

At operation 306, the instance of the computing resources is modified, according to a machine learning process, by allocating a second portion of the computing resources to the instance of the computing resources. In some examples, the first portion of the computing resources is augmented with the second portion of the computing resources (e.g., the second portion of the computing resources are added to, or pooled with, the first portion of the computing resources). In other examples, the first portion of the computing resources are replaced by the second portion of the computing resources. In some examples, the instance of the computing resources is modified without disrupting performance of the instance of the computing resources. For example, a user engaged in gaming via the instance of the computing resources implemented via the first portion of the computing resources may be unaware of the modification of the instance of the computing resources (e.g., the modification may occur without disruption to the gaming).

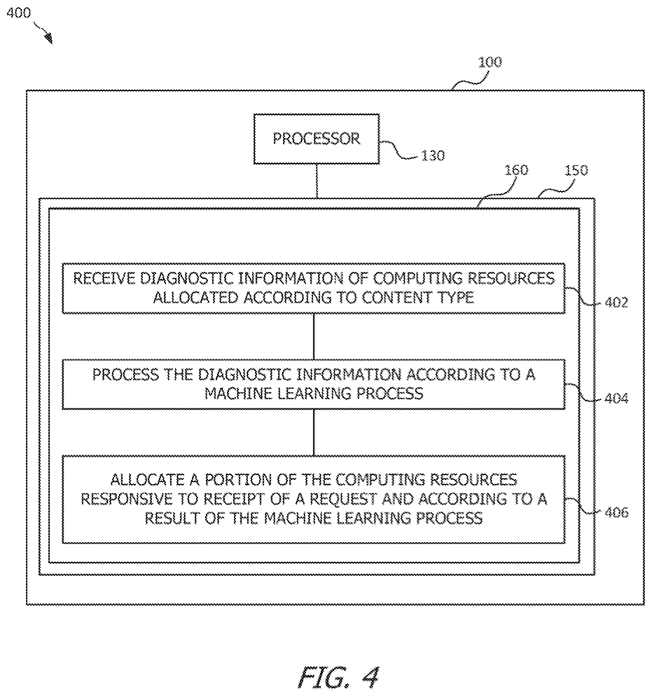

FIG. 4 is a flow diagram of a method 400 for allocation of computing resources to a user. In at least some examples, the method 400 may be suitable for implementation on an electronic device, such as the electronic device 100 of FIG. 1. Accordingly, the method 400 may be implemented at least in part as computer-executable instructions or code, stored on a computer-readable medium, such as the memory 150 of FIG. 1, which, when executed by a processor, such as the processor 130 of FIG. 1, may cause the processor 130 to execute computer-executable instructions, such as the resource distributor executable computer program product 160, to perform operations of the method 400. The method 400 is shown in FIG. 4 as instructions of the resource distributor executable computer program product 160, stored in the memory 150 of the electronic device 100. However, in other examples the method 400 may be implemented on other devices.

At operation 402, diagnostic information of computing resources allocated according to content type for use with the computing resources is received. In at least some examples, the diagnostic information is of allocations of computing resources to users other than a user providing a current request to allocated computing resources.

At operation 404, the diagnostic information is processed according to a machine learning process to determine a more appropriate computing resource for a particular content type. For example, the diagnostic information may be processed according to the machine learning process to update scores of the computing resources and/or update a feedback table associated with the computing resources. In some examples, the diagnostic information may indicate that at least some of the computing resources exhibit increased performance when used in conjunction with certain content types in comparison to other computing resources for those same content types.

At operation 406, a portion of the computing resources is allocated responsive to receipt of a request for allocation of computing resources and according to a result of the machine learning process. For example, the request may be received from a user and may indicate a content type for use with the computing resources. Based on the content type, a more appropriate computing resource for the content type may be determined, such as based on the processing of operation 404.

The above description is meant to be illustrative of the principles and various examples of the present disclosure. Numerous variations and modifications are contemplated. It is intended that the following claims be interpreted to embrace all such variations and modifications.

What is claimed is:

1. An electronic device, comprising:
a processor to:
receive a request to allocate computing resources, the request indicating a content type to use with the computing resources;
determine available computing resources;
determine a scoring of the computing resources according to the content type; and
allocate a portion of the available computing resources according to the request, the content type, and the scoring.

2. The electronic device of claim 1, wherein the processor is to determine the scoring of the computing resources according to the content type at least partially according to a machine learning process.

3. The electronic device of claim 2, wherein the scoring of the computing resources is unique to the request to allocate computing resources.

4. The electronic device of claim 1, wherein the processor is to allocate the portion of the available computing resources based on a physical proximity of the portion of the available computing resources to a user who provides the request to allocate computing resources.

5. The electronic device of claim 1, wherein the processor is to:
receive feedback indicating performance of the portion of the available computing resources; and
allocate a second portion of the available computing resources responsive to the feedback indicating the performance of the portion of the available computing resources is less than a threshold.

6. A method, comprising:
allocating a first portion of computing resources to a user as an instance of the computing resources;
monitoring feedback indicating performance of the first portion of the computing resources; and
modifying, according to a machine learning process, the instance of the computing resources by allocating a second portion of the computing resources to the instance of the computing resources without disrupting performance of the instance of the computing resources.

7. The method of claim 6, wherein the first portion of computing resources is allocated to the user at least partially according to a machine learning process.

8. The method of claim 6, wherein the instance of the computing resources is modified by augmenting the first portion of computing resources with the second portion of computing resources.

9. The method of claim 6, wherein the instance of the computing resources is modified by replacing the first portion of computing resources with the second portion of computing resources.

10. The method of claim 6, wherein the instance of the computing resources is modified responsive to the performance of the first portion of the computing resources being less than a threshold.

11. A computer-readable medium storing executable code, which, when executed by a processor of an electronic device, causes the processor to:
receive diagnostic information of computing resources allocated according to content type to use with the computing resources;
process the diagnostic information according to a machine learning process to determine a more appropriate computing resource for a particular content type; and
responsive to receipt of a request to allocate computing resources, allocate a portion of the computing resources according to a result of the machine learning process.

12. The computer-readable medium of claim 11, wherein the diagnostic information is historical data received prior to receipt of the request to allocate computing resources.

13. The computer-readable medium of claim 11, wherein the diagnostic information indicates performance metrics of the computing resources for the content type.

14. The computer-readable medium of claim 13, wherein performance metrics of a second portion of the computing resources are improved in quality than performance metrics of a first portion of the computing resources for the content type.

15. The computer-readable medium of claim 14, wherein the portion of the computing resources is the second portion of the computing resources.
